(19) United States
(12) Patent Application Publication
(10) Pub. No.: US 2006/0000163 A1
(43) Pub. Date: Jan. 5, 2006

(54) Insulation cage

(76) Inventor: Jean-Marc Schuttrumpf, Blansko (CZ)

Correspondence Address: RALPH C. FRANCIS;FRANCIS LAW GROUP, 1942 EMBARCADERO, OAKLAND, CA, 94606, US

(21) Appl. No.: 11/158,464

(22) Filed: Jun. 21, 2005

(30) Foreign Application Priority Data
Jul. 2, 2004 (CZ) PUV 2004-15622

(51) Int. Cl. E06B 1/04

(52) U.S. Cl. 52/213

(57) ABSTRACT

An insulating insert for improving the thermal characteristics of a metal frame, such as an aluminum window or door frame. The insert has an elongated hollow enclosure defining at least one air chamber and a plurality of spacers adapted to engage interior surfaces of a metal frame to secure the insert within the metal frame. Preferably, the spacers form a seal with the metal frame that substantially impedes air exchange. The invention also includes metal frames having such insulating inserts and methods of insulating metal frames with the inserts.

### CROSS-REFERENCE TO RELATED APPLICATIONS

This application claims the benefit of Czech Republic Application No. PUV 2004-15622, filed Jul. 2, 2004.

### FIELD OF THE PRESENT INVENTION

The present invention relates generally to aluminum frames used for building construction. More particularly, the invention relates to an insert for metal framed windows and doors that improves insulation.

### BACKGROUND OF THE INVENTION

Metal fenestration frames, particular those made from aluminum, are widely used in building construction. The metal frames generally include the jambs, sills and headers used to define the opening in a building as well as the rails and stiles that surround the glass of the window or form the structure of the door. Metal fenestration frames offer significant advantages over conventional wooden fenestration frames due to their greater strength, durability and ease of assembly. Being elongated members, such metal window frames are commonly formed from aluminum extrusions. By using differently shaped dies, nearly any shape of extrusion can be created. Due to the varied possibilities, extruded aluminum fenestration frames are much more versatile than wooden fenestration frames. The ease of manufacture also greatly reduces the relative cost of aluminum frames.

However, conventional aluminum fenestration frames are inadequately insulated and therefore suffer from poor energy efficiency. Aluminum and other metals are well known to be extremely effective conductors of heat. Accordingly, aluminum fenestration frames are often characterized by their inability to adequately isolate the conditioned airspace inside a building from the outside environment.

First attempts to improve the insulation value of an aluminum frame were directed to creating an air chamber by making a portion of the aluminum frame hollow. Compared to aluminum, air offers superior insulation characteristics. However, the aluminum material easily conducts heat around the air chamber. Thus, simply providing an aluminum frame with an air chamber does not provide adequate insulation.

Additional efforts to improve the insulation of an aluminum frame have involved creating the frame from an interior profile and an exterior profile secured together by insulating connectors. Although this method of construction does provide a thermal break to prevent direct conduction of heat from the exterior of the frame to the interior (or vice versa), the air chamber is still exposed to the aluminum frame. Thus, these prior art attempts have been largely ineffective because the air inside the aluminum frame is rapidly heated or cooled by the surrounding aluminum, chiefly because of aluminum's high thermal conductivity

Further attempts to improve the thermal efficiency of an aluminum fenestration frame have involved machining the aluminum frame to define more than one air chamber. Unfortunately, these attempts are generally unsatisfactory because aluminum's high thermal conductivity overcomes the insulation attributed to the additional air chambers, resulting in only minimal gains in thermal efficiency. Moreover, the manufacturing required to machine the additional chambers significantly increases the cost of such frames.

It is therefore an object of the present invention to provide an insulating insert adapted to improve the thermal efficiency of a metal fenestration frame.

It is a further object of the invention to provide an insulated metal fenestration frame that remains substantially easy to manufacture.

It is yet another object of the invention to reduce the noise produced by a metal frame having a hollow portion.

### SUMMARY OF THE INVENTION

In accordance with the above objects and those that will be mentioned and will become apparent below, an insulating insert for improving the thermal efficiency of a metal frame of this invention, comprises an elongated hollow enclosure defining at least one air chamber and a plurality of spacers adapted to engage interior surfaces of a metal frame to secure the insert within the metal frame. Preferably, the spacers form a seal with the metal frame that substantially impedes air exchange.

In one embodiment, the spacers include elastic tips that form the seal. Preferably, the elastic tips are formed by tapering edges of the spacers. Also preferably, the insert is formed by extrusion.

In one embodiment, the hollow enclosure comprises two pairs of substantially parallel opposing faces and wherein each face has at least two spacers that are oriented substantially perpendicularly to the face.

In a further embodiment of the invention, the enclosure defines a plurality of air chambers.

Preferably, the insert is formed from a polymeric material having low thermal conductivity, such as polyvinyl chloride or similar plastics.

In another embodiment, the invention comprises a metal frame with at least one hollow interior portion and an insert having an elongated hollow enclosure that defines at least one air chamber and a plurality of spacers, wherein the spacers engage interior surfaces of the hollow interior portion of the metal frame to secure the insert within the metal frame.

In the noted embodiment, the spacer form a seal with the interior surfaces of the hollow interior portion of the metal frame that substantially impedes air exchange. Preferably, the spacers further include elastic tips that form the seal.

In one embodiment, the insert is formed from a polymeric material having low thermal conductivity.

Preferably, the metal frame is configured to fenestrate a building. For example, the metal frame can be a window frame or a door frame.

In another embodiment of the invention, the metal frame includes a thermal break formed by insulating connectors and the insert forms at least one additional air chamber with the insulating connectors.

The invention also includes methods for insulating a metal frame, including the steps of providing a metal frame having a hollow interior portion, providing an insert having an elongated hollow enclosure that defines at least one air chamber and a plurality of spacers, and securing the insert within the hollow interior portion of the metal frame by engaging the spacers with interior surfaces of the metal frame, wherein the air chamber is isolated from the metal frame.

In the noted embodiments, the engagement of the spacers with the interior surfaces of the metal frame preferably forms a seal that substantially impedes air exchange.

The advantages of the invention thus include the provision of an insulating insert that improves the thermal efficiency of a metal fenestration frame. As can be appreciated, the invention provides an insulated metal fenestration frame that accommodates existing manufacturing processes.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a perspective view of an insulating insert embodying features of the invention;

FIG. 2 is a cross-sectional view of insulating insert shown in FIG. 1; and

FIG. 3 is a cross-sectional view of an aluminum window frame fitted with an insulating insert, according to the invention.

### DETAILED DESCRIPTION OF THE INVENTION

Before describing the present invention in detail, it is to be understood that this invention is not limited to particularly exemplified apparatus, systems, structures or methods as such may, of course, vary. Thus, although a number of apparatus, systems and methods similar or equivalent to those described herein can be used in the practice of the present invention, the preferred materials and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

### Definitions

The term “fenestration”, as used herein, means and includes an opening in a building, including windows and doors.

The term “frame”, as used herein, means and includes the portions secured to the building and the portions defining the window or door. Thus, the frame portions secured to the building include the vertical members, typically referred to as jambs and the horizontal members, typically referred to as headers and sills. Likewise, the frame portions defining the window or door include vertical members, typically referred to as stiles, and horizontal members, typically referred to as rails.

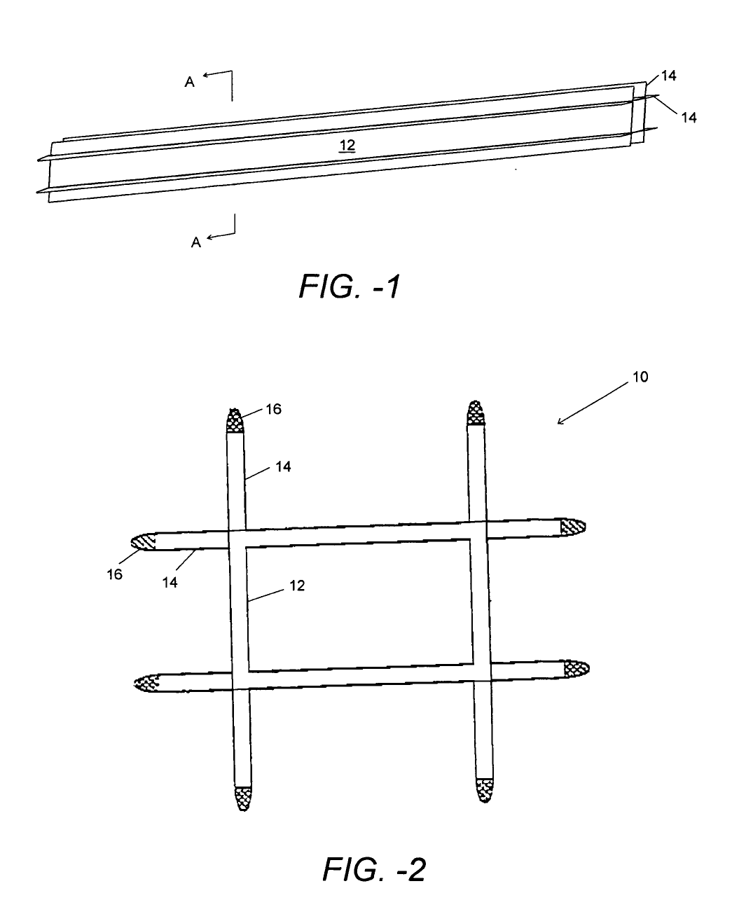

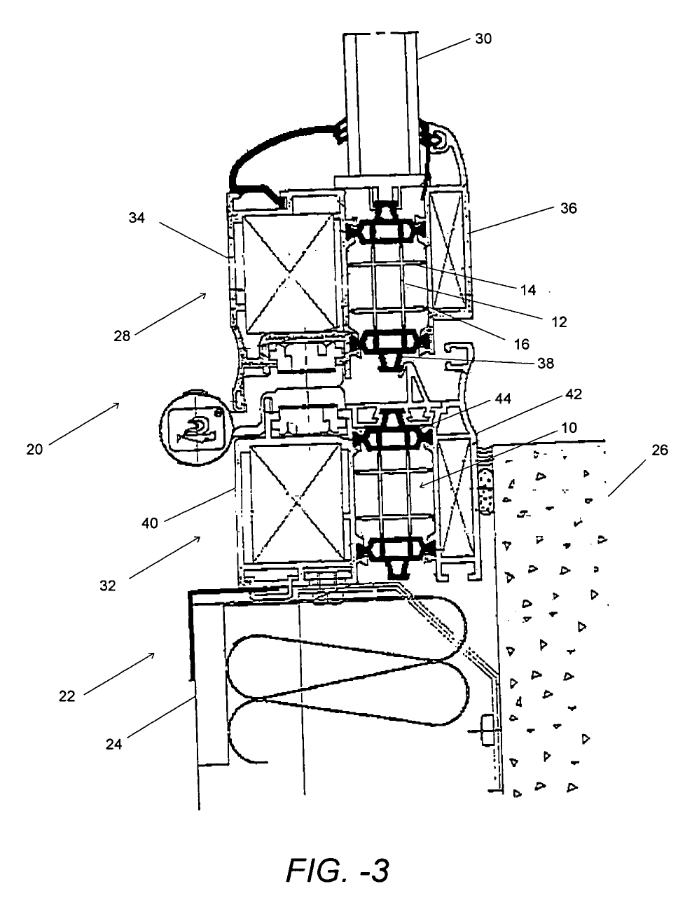

Referring to FIG. 1 there is shown a perspective view of an insulating insert 10 having features of the invention. A cross-section of insulating insert 10, taken at the line A-A, is shown in FIG. 2. Insulating insert 10 includes a hollow, elongated enclosure 12 having a plurality of spacers 14 projecting from the exterior of enclosure 12. As shown in greater detail in FIG. 2, spacers 14 preferably have elastic tips 16 running the length of each spacer. As will be described below, the elastic tips 16 seal against the metal frame to secure insulating insert 10 by friction. The seal formed by elastic tips 16 and the metal frame also substantially impedes airflow so as to define additional air chambers. The elastic tips 16 accommodate dimensional variations of the hollow inside the metal frame.

As one having ordinary skill in the art will recognize, the noted configuration of insulating insert 10 provide at least one air chamber defined by elongated enclosure 12 that is not contacted by the metal frame. As such, the air entrained by enclosure 12 is not exposed to the highly thermal conductive metal, greatly enhancing its insulative properties.

As can also be appreciated, the configuration shown in FIGS. 1 and 2 provide at additional air chambers, formed by spacers 14, and the metal frame.

As shown in FIGS. 1 and 2, a preferred configuration of insulating insert 10 provides a substantially rectangular profile having two pairs of substantially parallel opposing faces for enclosure 12 with spacers 14 projecting from each corner of the rectangle substantially perpendicularly to each face. As one having ordinary skill in the art will recognize, other shapes for enclosure 12 are suitable. For example, the enclosure can be configured to define any desired number of air chambers.

Additionally, enclosure 12 can be configured to substantially correspond to the shape of the hollow portion of the metal frame. Further, other spacer configurations can be used so long as sufficient spacers are provided to secure the enclosure within the metal frame. In particular, at least one spacer should be provided to engage each surface of the metal frame interior.

In general, enclosure 12, spacers 14 and elastic tips 16 can be formed from any material that exhibits lower thermal conductivity than the metal frame. Preferably, the material is an easily manufactured polymer, such as polyvinyl chloride (PVC) or other plastic. Elastic tips 16 can simply comprise the ends of spacers 14. More preferably, elastic tips 16 can be formed from the same material as spacers 14, but exhibit a tapered profile to improve the elasticity of the tips relative to the body of the spacers, thus forming a better seal with the metal frame. In a preferred embodiment, the entire insulating insert 10, including enclosure 12, spacers 14 and tips 16 is formed in one step by an extrusion process. Alternatively, elastic tips 16 can be formed from a different material having the desired characteristics, and suitably secured to the spacers.

Referring now to FIG. 3, a conventional aluminum window frame 20 having a thermal break is shown secured within a wall 22 of a building. In this embodiment, wall 22 comprises insulated interior framing 24 and an exterior concrete structure 26. As shown frame 20 includes rail 28 that secures window glass 30 and sill 32 attached to wall 22. As discussed above, the frame also includes stiles, jambs and headers. Rail 28 generally includes an interior aluminum profile 34 and an exterior aluminum profile 36 secured together by insulating connectors 38. Likewise, sill 32 also includes an interior aluminum profile 40 and an exterior aluminum profile 42 secured together by insulating connectors 44.

As shown, insulating insert 10 is adapted to friction fit within the space defined by the interior and exterior aluminum profiles and the insulating connectors. Specifically, elastic tips 16 of spacers 14 engage the aluminum profiles 34, 36, 40 and 42 and the insulating connectors 38 and 44, anchoring insert 10 within the frame 20 and forming substantially seals at the connection between the spacers and the frame. The seals do not need to be perfectly air tight, but preferably impede the exchange of air between the air chambers formed by the seals. By reducing the degree of air exchange, the insulating properties of the aluminum frame are enhanced.

As one having ordinary skill in the art will appreciate, one air chamber that is totally isolated from the aluminum portions of frame 20 is formed by enclosure 12. Further, in the noted embodiment, two additional air chambers are formed by spacers 14, insulating connectors 38 and 44 and the exterior of enclosure 12. Since insulating connectors 38 and 44 are formed from a material having lower thermal conductivity than aluminum, these additional air chambers also provide a significant insulating benefit.

Further, air chambers are also defined by the spacers 14 and the interior and exterior aluminum profiles 24, 36, 40 and 42. These chambers do not provide the same insulation characteristics as the air chamber formed by enclosure 12, or those formed in by the spacers in conjunction with the insulating connectors, because they are exposed to the aluminum frame. However, the additional air chambers still contribute to the thermal efficiency to some degree.

In addition to the improved insulation provided by insert 10, this invention also enhances the aesthetics of a metal frame by reducing unwanted noise. Specifically, metal frames having a hollow portion without an insert tend to produce exaggerated noises due to the ability of sound waves to resonate within the hollow cavity of the frames. The inventive insulating inserts of the invention break up these spaces, reducing the production of these unwanted noises. In turn, the metal frames equipped with the noted inserts have a more substantial “feel,” instead of conveying the impression that they are hollow.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. An insulating insert for improving the thermal efficiency of a metal frame, comprising an elongated hollow enclosure defining at least one air chamber and a plurality of spacers adapted to engage interior surfaces of a metal frame to secure said insert within said metal frame.

2. The insulating insert of claim 1, wherein said spacers are adapted to form a seal with said metal frame that substantially impedes air exchange.

3. The insulating insert of claim 2, wherein said spacers further comprise elastic tips that form said seal.

4. The insulating insert of claim 3, wherein said elastic tips are formed by tapering edges of said spacers.

5. The insulating insert of claim 4, wherein said insert is formed by extrusion.

6. The insulating insert of claim 1, wherein said hollow enclosure comprises two pairs of substantially parallel opposing faces and wherein each face has at least two spacers that are oriented substantially perpendicularly to said face.

7. The insulating insert of claim 1, wherein said enclosure defines a plurality of air chambers.

8. The insulating insert of claim 1, wherein said insert is formed from a polymeric material having low thermal conductivity.

9. The insulating insert of claim 8, wherein said insert is formed from polyvinyl chloride.

10. A metal frame comprising at least one hollow interior portion defined by interior surfaces of said metal frame and an insert having an elongated hollow enclosure that defines at least one air chamber and a plurality of spacers, wherein said spacers engage said interior surfaces of said metal frame to secure said insert within said metal frame.

11. The metal frame of claim 10, wherein said spacer form a seal with said interior surfaces of said hollow interior portion of said metal frame that substantially impedes air exchange.

12. The metal frame of claim 11, wherein said spacers further comprise elastic tips that form said seal.

13. The metal frame of claim 11, wherein said insert is formed from a polymeric material having low thermal conductivity.

14. The metal frame of claim 10, wherein said metal frame is configured to fenestrate a building.

15. The metal frame of claim 14, wherein said metal frame is a window frame.

16. The metal frame of claim 14, wherein said metal frame is a door frame.

17. The metal frame of claim 10, wherein said metal frame further comprises a thermal break formed by insulating connectors and wherein at least one additional air chamber is formed by said insert and said insulating connectors.

18. A method for insulating a metal frame, comprising the steps of:
providing a metal frame having a hollow interior portion defined by interior surfaces of said metal frame,
providing an insert having an elongated hollow enclosure that defines at least one air chamber and a plurality of spacers, and
securing said insert within said hollow interior portion of said metal frame by engaging said spacers with said interior surfaces of said metal frame, wherein said air chamber is isolated from said metal frame.

19. The method of claim 17, wherein said engagement of said spacers with interior surfaces of said metal frame forms a seal that substantially impedes air exchange.
